(19) United States
(12) Patent Application Publication
(10) Pub. No.: US 2026/0343165 A1
(43) Pub. Date: Oct. 29, 2026

(54) ACOUSTIC SIGNAL PROCESSING APPARATUS

(71) Applicant: ALPS ALPINE CO., LTD., Tokyo (JP)

(72) Inventors: Keita TANNO, Tokyo (JP); Nozomu SAITO, Fukushima (JP)

(21) Appl. No.: 19/646,072

(22) Filed: Apr. 13, 2026

(30) Foreign Application Priority Data
Apr. 24, 2025 (JP) 2025-072300

(51) Int. Cl. H04S 7/00; H04S 1/00

(52) U.S. Cl. CPC H04S 7/302; H04S 1/007; H04S 2400/11; H04S 2420/01

(57) ABSTRACT

An acoustic signal processing apparatus includes filter processing circuitry configured to filter an input stereo acoustic signal with a filter coefficient implementing a predetermined transfer function, and output the filtered stereo acoustic signal from a stereo speaker. The predetermined transfer function of the filter processing circuitry is a function including only a numerator and no denominator, the predetermined transfer function including a sign-inverted transfer function obtained by inverting a sign of a transfer function representing a spatial acoustic characteristic of a crosstalk component of sound that travels from the stereo speaker to left and right listening points.

### CROSS-REFERENCE TO RELATED APPLICATIONS

The present application is based on and claims priority to Japanese patent application No. 2025-072300, filed on Apr. 24, 2025, with the Japanese Patent Office, the entire contents of which are hereby incorporated by reference.

### TECHNICAL FIELD

The present disclosure relates to an acoustic signal processing apparatus.

### BACKGROUND

A spatial image of sound perceived by a human being with respect to a certain sound source is called a sound image. Perceiving a spatial position of the sound image (direction and distance in which sound is heard) is called sound image localization. Conventionally, a sound image localization device that imparts, to an input sound signal, the sound image that is localized at a predetermined spatial position is known. By appropriately controlling sound image localization, it is possible to reproduce spatial sound with a more realistic feeling and to impart a sense of direction to sound reaching a listener's ear. For example, it is possible to impart the sound image localized such that sound is heard from a specific direction.

Patent Document 1 discloses a sound image localization device in which the position of a sound source can be clearly recognized in sound reproduction using earphones or headphones. However, in a case of sound image localization using the earphones or the headphones, if a listener moves his/her head in the direction of sound when the listener senses the direction of the sound, there is a problem that the earphones or the headphones move with the movement of his/her head and the direction of the sound also moves simultaneously.

Patent Document 2 discloses a sound image localization device which adds rear localization using a model head-related transfer function from the rear to both ears when a sound source of 5 channels is mixed down and combined into 2 channels, and performs crosstalk cancellation correction in order to ensure the effectiveness of the rear localization addition. In a reproduction system using speakers instead of earphones or headphones, there is a problem that crosstalk occurs such that sound for the right ear reaches the left ear and sound for the left ear reaches the right ear. In the sound image localization device disclosed in Patent Document 2, crosstalk is canceled when surround sound of 5 channels is mixed down into stereo sound of 2 channels.

### RELATED-ART DOCUMENTS

### Patent Documents

Patent Document 1: Japanese Unexamined Patent Publication No. 2002-209300
Patent Document 2: Japanese Unexamined Patent Publication No. 2007-110206

### SUMMARY

An acoustic signal processing apparatus in the present disclosure includes filter processing circuitry configured to filter an input stereo acoustic signal with a filter coefficient implementing a predetermined transfer function, and output the filtered stereo acoustic signal from a stereo speaker. The predetermined transfer function of the filter processing circuitry is a function including only a numerator and no denominator, the predetermined transfer function including a sign-inverted transfer function obtained by inverting a sign of a transfer function representing a spatial acoustic characteristic of a crosstalk component of sound that travels from the stereo speaker to left and right listening points.

### BRIEF DESCRIPTION OF THE DRAWINGS

FIG. 1 is a diagram schematically showing a mechanism of a transaural system.

FIG. 2A is a diagram showing a configuration example of an acoustic signal processing apparatus according to the present embodiment.

FIG. 2B is a diagram showing another configuration example of the acoustic signal processing apparatus according to the present embodiment.

FIG. 2C is a diagram showing another configuration example of the acoustic signal processing apparatus according to the present embodiment.

FIG. 3 is a diagram showing a configuration example of an acoustic signal processing apparatus according to a first modification.

FIG. 4 is a diagram showing a configuration example of an acoustic signal processing apparatus according to a second modification.

FIG. 5 is a diagram showing a configuration example of an acoustic signal processing apparatus according to a third modification.

### DETAILED DESCRIPTION

One of the methods to deal with the crosstalk problem described above is a technology called transaural. A transaural system is a system in which binaural recording is performed with a dummy head imitating a human head, and recorded sound is reproduced by stereo speakers instead of headphones. In the transaural system, a transfer function filter is set based on a reverse calculation of how a signal reproduced from a 2-channel speaker changes in the process of reaching a listening point (positions of both ears) from the speaker, and attempts to reproduce the sound that is binaurally recorded in an original sound field (sound without crosstalk), at the listening point in the reproduced sound field.

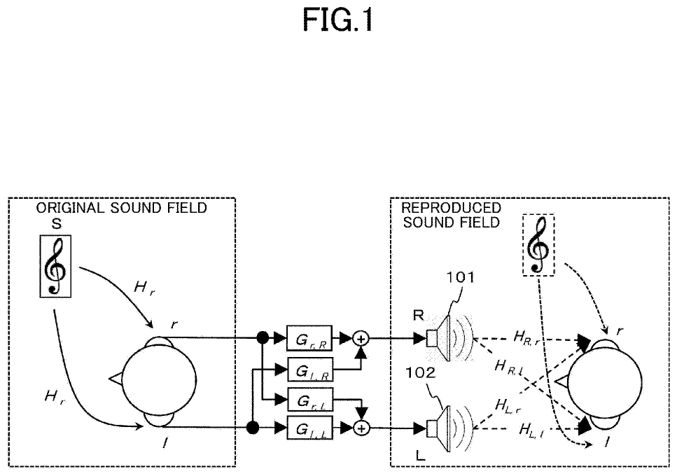

FIG. 1 shows a schematic diagram of a mechanism of the transaural system. In FIG. 1, sound emitted from a sound source S in an original sound field reaches a right ear under the influence of a spatial transfer function Hᵣ, and reaches a left ear under the influence of a spatial transfer function Hₗ. On the other hand, when the recorded sound of the sound source S is output as is from loudspeakers 101 and 102 of Lch and Rch in the reproduced sound field, since sound under the influence of spatial transfer functions H_{R,r} and H_{L,r} reaches the right ear, the sound reaching the right ear is not the same as the sound output from the loudspeaker 101 of Rch, and is different therefrom. Similarly, since the sound under the influence of the spatial transfer functions HR,1 and HL,1 reaches the left ear, the sound reaching the left ear is not the same as the sound output from the loudspeaker 102 of Lch, and is different therefrom. In contrast, in the transaural system, an acoustic filter having a transfer function G that cancels the influence of a spatial transfer characteristic (a filter having a characteristic opposite to the spatial transfer characteristic) is configured, and the received sounds 1 and r in the reproduced sound field become the same received sounds 1 and r as those in the original sound field by filtering the received sound signal obtained in the original sound field.

The transfer function G of the acoustic filter used in the transaural system is expressed by Equation 1 below. In Equation 1, the transfer function {H_{L,l}(ω)H_{R,r}(ω)−H_{L,r}(ω)H_{R,l}(ω)}⁻¹ represents the inverse transfer function (also called an inverse system or an inverse filter) of the transfer function {H_{L,l}(ω)H_{R,r}(ω)−H_{L,r}(ω)H_{R,l}(ω)}. As shown by Equation 1, the transfer function G set in the acoustic filter in the transaural system includes a transfer function in the denominator. As a result, there has been a problem that a calculation result of the transfer function G becomes unstable depending on the situation of the reproduced sound field, and stable operation of the system is not guaranteed.

$$\begin{matrix}\begin{matrix}[ Math . 1 ] \\ ( 1 )\end{matrix} & \\ \{ \begin{matrix}\frac{{H}_{R , t} ( ω )}{{H}_{L , 1} ( ω ) {H}_{R , r} ( ω ) - {H}_{L , r} ( ω ) {H}_{R , 1} ( ω )} \\ \text{?} ( ω ) = \frac{- {H}_{R , 1} ( ω )}{{H}_{L , 1} ( ω ) {H}_{R , r} ( ω ) - {H}_{L , r} ( ω ) {H}_{R , 1} ( ω )} \\ \text{?} ( ω ) = \frac{- {H}_{L , r} ( ω )}{{H}_{L , 1} ( ω ) \text{?} ( ω ) - {H}_{L , r} ( ω ) {H}_{R , 1} ( ω )} \\ {G}_{t , R} ( ω ) = \frac{{H}_{L , 1} ( ω )}{{H}_{L , 1} ( ω ) \text{?} ( ω ) - \text{?} ( ω ) {H}_{R , 1} ( ω )}\end{matrix} & ( \text{?} 0 )\end{matrix}$$

$$\text{?} \text{indicates text missing or illegible when filed}$$

In light of the above problem, an object of the present disclosure is to reduce crosstalk in a sound reproduction system using a stereo speaker without impairing the stability of the system.

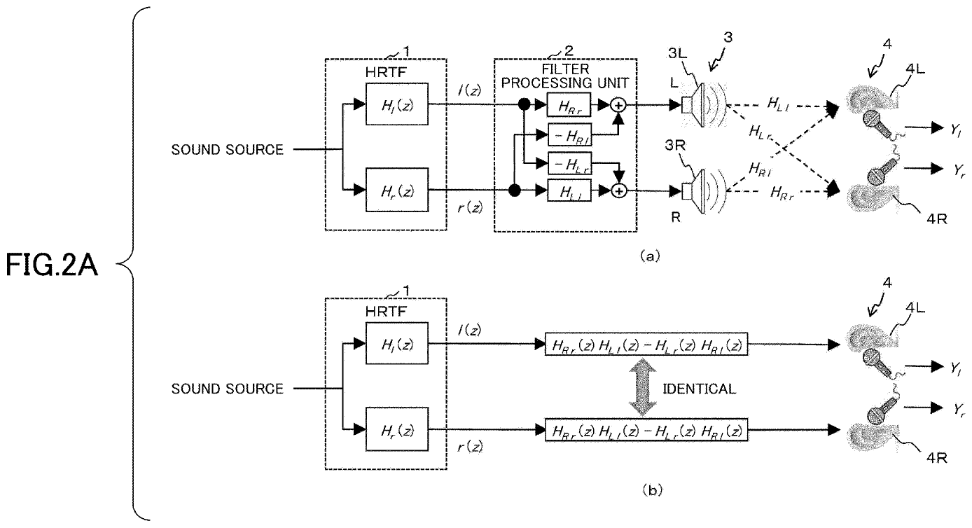

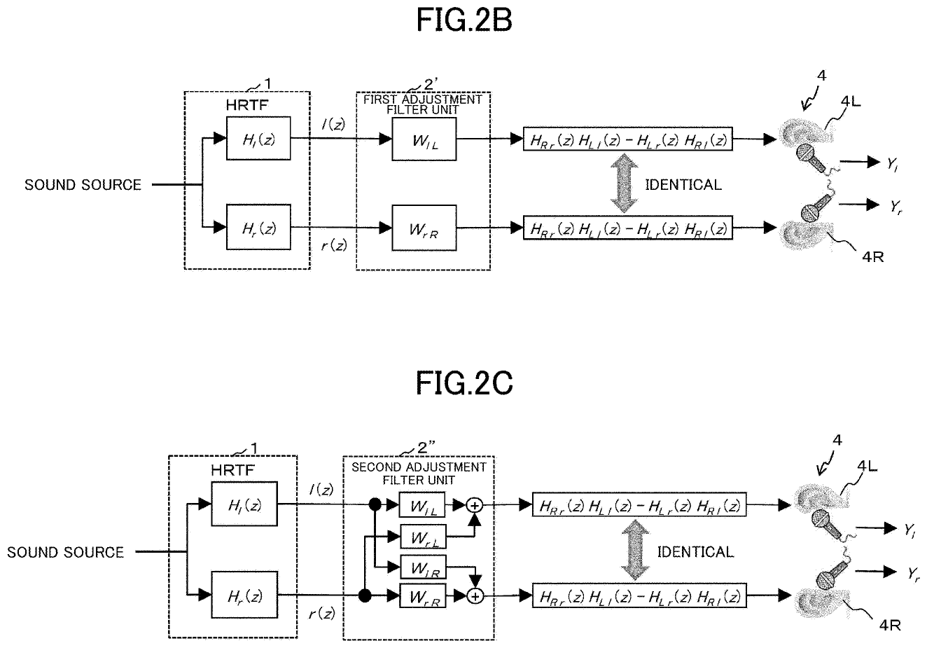

Hereinafter, one embodiment of the present disclosure will be described with reference to the drawings. As shown in FIG. 2A(a), an acoustic signal processing apparatus of the present embodiment includes a head-related transfer function processing unit 1 and a filter processing unit 2.

The head-related transfer function processing unit 1 generates stereo acoustic signals l(z) and r(z) by filtering an acoustic signal of a sound source using a filter whose filter coefficients implement left and right head-related transfer functions Hₗ(z) and Hᵣ(z). In the following description, the expression “filtering is performed using transfer functions” may be used, but this is an abbreviated expression meaning “filtering is performed using a filter whose filter coefficients implement transfer functions.”

A head-related transfer function (HRTF) is a function representing transmission characteristics of a sound wave until the sound wave reaches the entrance of an ear canal of a listener through reflection and diffraction at the head, pinna, or the like. The HRTF is a function set depending on physical characteristics such as the shape of the head and pinna of the listener.

As an example, the head-related transfer functions Hₗ(z) and Hᵣ(z) are measured by collecting, at the entrance of the ear canal, sound output from a loudspeaker installed around a dummy head and by performing known signal processing on the collected sound signal. The head-related transfer function processing unit 1 is constituted by a filter in which the head-related transfer functions Hₗ(z) and Hᵣ(z) measured in such a manner are set as filter coefficients. Desired sound image localization can be performed according to the set head-related transfer functions Hₗ(z) and Hᵣ(z). For example, it is possible to give a sense of direction to the sound that reaches left and right listening points 4 (the left and right ears of the listener or left and right microphones).

The filter processing unit 2 filters the stereo acoustic signals l(z) and r(z) input from the head-related transfer function processing unit 1, with a predetermined transfer function, and outputs the filtered stereo acoustic signals from a stereo speaker 3 (left and right speakers 3L and 3R). The filter processing unit 2 is composed of a finite impulse response (FIR) filter in which filter coefficients for implementing a predetermined transfer function are set.

As shown in FIG. 2A(a), the filter transfer functions of the filter processing unit 2 have four transfer functions: a transfer function H_{Rr} representing the spatial acoustic characteristics until the sound output from the right speaker 3R reaches a right listening point 4R; a transfer function −H_{Rl} obtained by inverting the sign of the transfer function H_{Rl} representing the spatial acoustic characteristics until the sound output from the right speaker 3R reaches a left listening point 4L; a transfer function −H_{Lr} obtained by inverting the sign of the function H_{Lr} representing the spatial acoustic characteristics until the sound output from the left speaker 3L reaches the right listening point 4R; and a transfer function H_{Ll} representing the spatial acoustic characteristics until the sound output from the left speaker 3L reaches the left listening point 4L. The two transfer functions H_{Rr} and H_{Ll} represent the spatial acoustic characteristics related to a direct component of the sound that reaches the left and right listening points 4L and 4R, and the two transfer functions H_{Rl} and H_{Lr} represent the spatial acoustic characteristics related to a crosstalk component of the sound that reaches the left and right listening points 4L and 4R.

All of the four filter transfer functions H_{Rr}, −H_{Rl}, −H_{Lr}, and H_{Ll} that are implemented in the filter of the filter processing unit 2 are functions having only a numerator and no denominator, unlike the transfer function G shown in FIG. 1. The transfer functions −H_{Rl} and −H_{Lr} among the four filter transfer functions are sign-inverted transfer functions obtained by inverting the sign of the transfer functions representing the spatial acoustic characteristics of the crosstalk component, which is the sound that travels from the left and right speakers 3L and 3R to the opposite listening points 4R and 4L.

The filter processing unit 2 filters the stereo acoustic signals l(z) and r(z) input from the head-related transfer function processing unit 1 by a multiply-accumulate operation that uses a multiplier and an adder of a filter, which implements the four transfer functions H_{Rr}, −H_{Rl}, −H_{Lr}, and H_{Ll}. Then, the filter processing unit 2 outputs the filtered stereo acoustic signals from the stereo speaker 3. Equation 2 shows the multiply-accumulate operation performed in the filter processing unit 2.

$$\begin{matrix}\begin{matrix}[ Math . 2 ] \\ ( 2 )\end{matrix} & \\ \text{?} = ( \begin{matrix}\text{?} & - {H}_{Lr} \\ - {H}_{R 1} & {H}_{L 1}\end{matrix} ) & ( \text{?} 1 )\end{matrix}$$

$$\text{?} \text{indicates text missing or illegible when filed}$$

FIG. 2A(b) shows a configuration mathematically equivalent to that of the acoustic signal processing apparatus shown in FIG. 2A(a). That is, the stereo acoustic signals l(z) and r(z) output from the head-related transfer function processing unit 1 propagate to the listening point 4 (right and left listening points 4L and 4R) under the influence of the acoustic characteristics modeled by the transfer functions shown in FIG. 2A(b). The transfer function shown in FIG. 2A(b) is obtained by multiplying the four transfer functions H_{Rr}, −H_{Rl}, −H_{Lr}, and H_{Ll} set in the filter processing unit 2 by the four spatial transfer functions H_{Rr}, H_{Rl}, H_{Lr}, and H_{Ll} representing the spatial acoustic characteristics from the left and right speakers 3L and 3R to the left and right listening points 4L and 4R, as shown in Equation 3.

$$\begin{matrix}\begin{matrix}[ Math . 3 ] \\ ( 3 )\end{matrix} & \\ \begin{matrix}( \begin{matrix}{Y}_{l} & {Y}_{r}\end{matrix} ) = ( \begin{matrix}l & r\end{matrix} ) ( \begin{matrix}{H}_{Rr} & - {H}_{Lr} \\ - {H}_{R 1} & {H}_{L 1}\end{matrix} ) ( \begin{matrix}{H}_{L 1} & {H}_{L r} \\ {H}_{R 1} & {H}_{Rr}\end{matrix} ) \\ = ( \begin{matrix}l & r\end{matrix} ) ( \begin{matrix}{H}_{Rr} {H}_{L 1} - {H}_{Lr} {H}_{R 1} & {H}_{Rr} {H}_{Lr} - {H}_{Lr} {H}_{R r} \\ - {H}_{R 1} {H}_{L 1} + {H}_{L 1} {H}_{R 1} & - {H}_{R 1} {H}_{Lr} + {H}_{L 1} {H}_{Rr}\end{matrix} ) \\ = ( \begin{matrix}l & r\end{matrix} ) ( \begin{matrix}{H}_{Rr} {H}_{L 1} - {H}_{Lr} {H}_{R 1} & 0 \\ 0 & {H}_{L 1} {H}_{R 1} - {H}_{R 1} {H}_{Lr}\end{matrix} )\end{matrix} & ( \text{?} 2 )\end{matrix}$$

As shown in FIG. 2A(b), in the transmission path of the stereo acoustic signals l(z) and r(z) output from the head-related transfer function processing unit 1 until these signals reach the listening point 4 via the filter processing unit 2 and the stereo loudspeaker 3, the crosstalk component is canceled and only a direct component is generated. Further, the transfer function related to the acoustic signal l(z) of Lch and the transfer function related to the acoustic signal r(z) of Rch become equal to each other.

In order to adjust the input/output characteristics represented by Equation 3 above so as to approximate desired characteristics, a first adjustment filter unit 2′ having filter coefficients W_{lL}(z) and W_{rR}(Z) as shown in FIG. 2B may be added. In this configuration, for example, it is possible to approximate the characteristics of the transmission system that remain as a result of cancellation of the crosstalk component to desired characteristics.

The four spatial transfer functions H_{Rr}, H_{Rl}, H_{Lr}, and H_{Ll} used in the filter processing unit 2 of FIG. 2A(a) are ideally obtained individually for each person wearing an earplug microphone, but in practice, these spatial transfer functions are often represented by those obtained using a dummy head or those measured on a specific person wearing an earplug microphone. In this case, since the spatial transfer functions H_{Rr}, H_{Rl}, H_{Lr}, and H_{Ll} are slightly different from those of each individual, it is also possible to use a second adjustment filter unit 2″ having filter coefficients W_{lL}, W_{rL}, W_{lR}, and W_{rR} in which crosstalk components are intentionally added as shown in FIG. 2C in order to correct the deviation. The second adjustment filter unit 2″ is a two-input, two-output filter matrix system for adjusting both the direct component and the crosstalk component of the sound reaching the listening point 4. Since the filter processing unit 2 converts the system into one in which the crosstalk component is canceled as shown in FIG. 2A(b), the configuration shown in FIG. 2C makes it possible to easily set and adjust the crosstalk component to be finally mixed, using only the second adjustment filter unit 2″.

As described above, in the acoustic signal processing apparatus of this embodiment, since a function having only a numerator and no denominator is used as the filter transfer function of the filter processing unit 2, it is possible to eliminate the instability in which the denominator of the filter transfer function becomes zero, causing the function to diverge to infinity. Further, since a function including the sign-inverted transfer function of the crosstalk component is used as the filter transfer function of the filter processing unit 2, it is possible to output, from the stereo speaker 3, sound in which the crosstalk component is canceled in the transmission path to the listening point 4. Thus, in the sound reproduction system using the stereo speaker 3, crosstalk can be reduced without impairing the stability of the system. Further, by adding the first adjustment filter unit 2′, the input/output characteristics of the two systems obtained by reducing crosstalk can be adjusted to desired characteristics. Furthermore, by using the second adjustment filter unit 2″, it is possible to easily set and adjust the crosstalk component to be finally mixed.

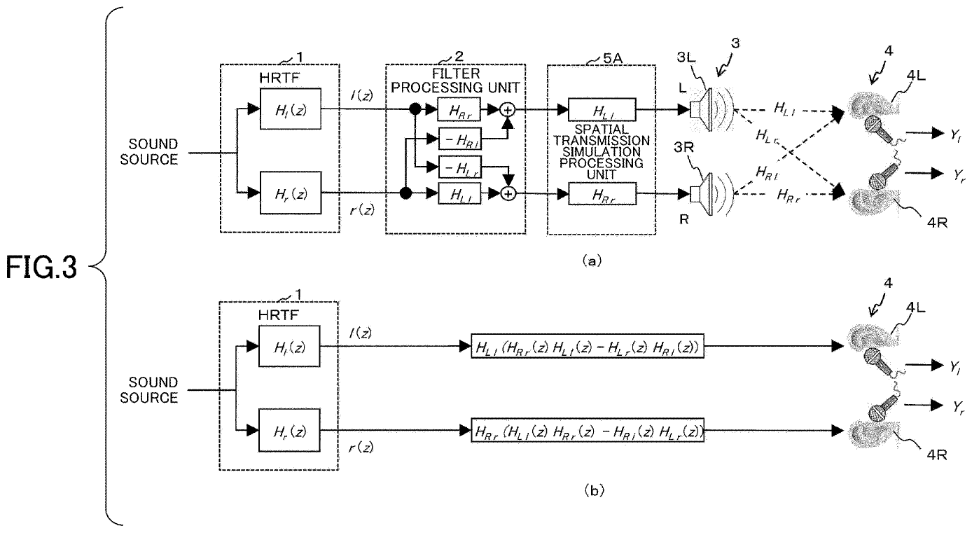

Modifications of the acoustic signal processing apparatus according to the present embodiment will be described below with reference to FIGS. 3 to 5. Each of the modifications shown in FIGS. 3 to 5 is obtained by further adding the configuration of spatial transmission simulation processing units 5A and 5B described in detail below. The spatial transmission simulation processing units 5A and 5B filter the stereo acoustic signal that is filtered by the filter processing unit 2 with a simulated transfer function that simulates predetermined spatial acoustic characteristics from the stereo speaker 3 to the left and right listening points 4L and 4R. Then, the stereo acoustic signal filtered by both the filter processing unit 2 and the spatial transmission simulation processing units 5A and 5B is output from the stereo speaker 3.

FIG. 3 is a diagram showing a configuration example of the acoustic signal processing apparatus according to a first modification. As shown in FIG. 3(a), the acoustic signal processing apparatus according to the first modification includes a spatial transmission simulation processing unit 5A at a stage subsequent to the filter processing unit 2. A simulated transfer function set in the filter of the spatial transmission simulation processing unit 5A is a function having only a numerator and no denominator, and is a function that does not include a transfer function representing the spatial acoustic characteristics of the crosstalk component.

Specifically, the simulated transfer function of the spatial transmission simulation processing unit 5A includes a transfer function H_{Ll} simulating the spatial acoustic characteristics of the direct component that reaches the left listening point 4L from the left speaker 3L; and a transfer function H_{Rr} simulating the spatial acoustic characteristics of the direct component that reaches the right listening point 4R from the right speaker 3R.

The spatial transmission simulation processing unit 5A filters the acoustic signal of Lch filtered by the filter processing unit 2 with the transfer function H_{Ll} related to a left-side direct component, and filters the acoustic signal of Rch filtered by the filter processing unit 2 with the transfer function H_{Rr} related to a right-side direct component. Then, the stereo acoustic signal filtered by the spatial transmission simulation processing unit 5A is output from the stereo speaker 3.

The acoustic signal processing apparatus shown in FIG. 3(a) can be approximately expressed as a system as shown in FIG. 3(b), and the relationship between [lr] and [YₗYᵣ] can be expressed by Equation 4.

$$\begin{matrix}\begin{matrix}[ Math . 4 ] \\ ( 4 )\end{matrix} & \\ ( \begin{matrix}{Y}_{l} & {Y}_{r}\end{matrix} ) \approx ( \begin{matrix}l & r\end{matrix} ) ( \begin{matrix}{H}_{L 1} ( {H}_{Rr} {H}_{L 1} - {H}_{Lr} {H}_{R 1} ) & 0 \\ 0 & {H}_{Rr} ( {H}_{L 1} {H}_{Rr} - {H}_{R 1} {H}_{Lr} )\end{matrix} ) & ( \text{?} 3 )\end{matrix}$$

In the acoustic signal processing apparatus of the first modification configured as described above, the spatial transmission simulation processing unit 5A performs filtering with a simulated transfer function simulating the spatial acoustic characteristics of the sound of the direct component that is originally required at the listening point 4, and thereafter, the spatial acoustic characteristics of the direct component are further added until the sound output from the stereo speaker 3 reaches the listening point 4 through the space. In other words, the sound reaches the listening point 4 in a state where the influence of the direct component is doubly applied, and the spatial acoustic characteristics of the direct component required are emphasized and reproduced at the ear. Thus, the sound of the direct component can be reproduced more richly while suppressing the crosstalk component. Further, since the head-related transfer function is further convolved in the head-related transfer function processing unit 1, the listener can hear the sound in a state in which the characteristics of the sense of direction and the sense of distance are more emphasized at the listening point 4.

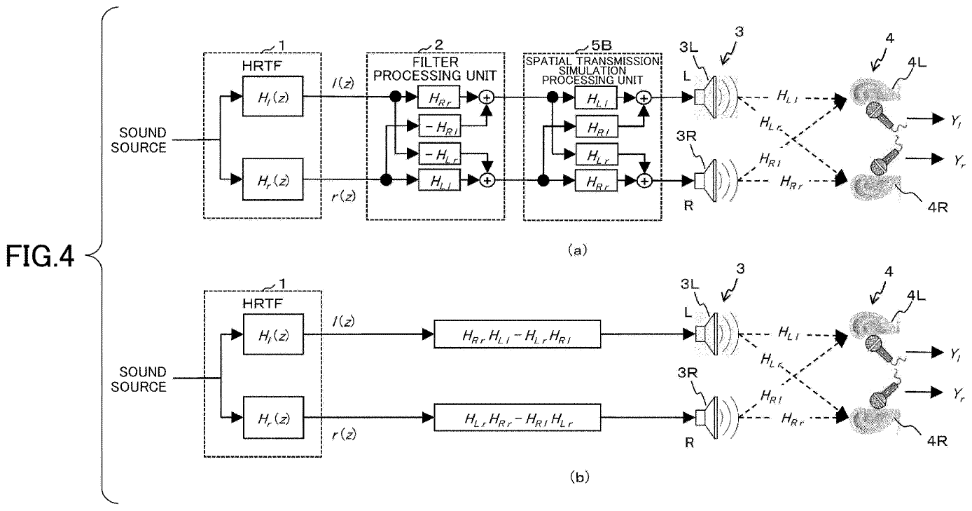

FIG. 4 is a diagram showing a configuration example of the acoustic signal processing apparatus according to a second modification. As shown in FIG. 4(a), the acoustic signal processing apparatus according to the second modification includes a spatial transfer simulation processing unit 5B at a stage subsequent to the filter processing unit 2. The simulated transfer function set in the filter of the spatial transfer simulation processing unit 5B is a function having only a numerator and no denominator, and is a function that includes a transfer function representing the spatial acoustic characteristics of the crosstalk component.

Specifically, the simulated transfer function of the spatial transfer simulation processing unit 5B includes two transfer functions H_{Rr} and H_{Ll} simulating the spatial acoustic characteristics related to the direct component of the sound that reaches the left and right listening points 4L and 4R from the stereo speaker 3, and includes two transfer functions H_{Rl} and H_{Lr} simulating the spatial acoustic characteristics related to the crosstalk component of the sound that reaches the left and right listening points 4L and 4R from the stereo speaker 3.

The spatial transfer simulation processing unit 5B performs filtering on the stereo acoustic signal filtered by the filter processing unit 2 by a multiplication-addition operation using a multiplier and an adder of a filter that implements the four transfer functions H_{Rr}, H_{Rl}, H_{Lr}, and H_{Ll}. Then, the stereo acoustic signal filtered by the spatial transfer simulation processing unit 5B is output from the stereo speaker 3.

The acoustic signal processing apparatus shown in FIG. 4(a) can be approximately expressed as a system as shown in FIG. 4(b), and the relationship between [lr] and [YₗYᵣ] can be expressed by Equation 5. The system shown in FIG. 4(b) expressed by Equation 5 is equivalent to the system in which W_{lL}=H_{Ll}, W_{lR}=H_{Rl}, W_{rL}=H_{lR}, and W_{rR}=H_{Rr} in FIG. 2C.

$$\begin{matrix}\begin{matrix}[ Math . 5 ] \\ ( 5 )\end{matrix} & \\ ( \begin{matrix}{Y}_{l} & {Y}_{r}\end{matrix} ) = ( \begin{matrix}l & r\end{matrix} ) ( \begin{matrix}{H}_{L 1} ( {H}_{Rr} {H}_{L 1} - {H}_{Lr} {H}_{R 1} ) & {H}_{Lr} ( {H}_{Rr} {H}_{L 1} - {H}_{Lr} {H}_{R 1} ) \\ {H}_{R 1} ( {H}_{L 1} {H}_{Rr} - {H}_{R 1} {H}_{Lr} ) & {H}_{Rr} ( {H}_{L 1} {H}_{Rr} - {H}_{R 1} {H}_{Lr} )\end{matrix} ) & ( \text{?} 4 )\end{matrix}$$

In the acoustic signal processing apparatus of the second modification configured as described above, the spatial transmission simulation processing unit 5B performs filtering with a simulated transfer function that simulates the spatial acoustic characteristics of the sound including both the direct component and the crosstalk component. Then, the spatial transmission simulation processing unit 5B applies the similar spatial acoustic characteristics to the sound output from the stereo speaker 3 until the sound actually travels through the space and reaches the listening point 4. That is, the sound is input to the stereo speaker 3 in a state where the crosstalk component is suppressed by the processing of the filter processing unit 2 and the processing of the spatial transmission simulation processing unit 5B, and reaches the listening point 4 in such a manner that the influence of the spatial acoustic characteristics is applied as is, only in the final stage. In other words, it is possible to obtain a state where the influence of the direct component is applied twice and the crosstalk component is also adjusted as necessary. In this arrangement, it is possible to more richly reproduce the sense of distance and spaciousness of the sound.

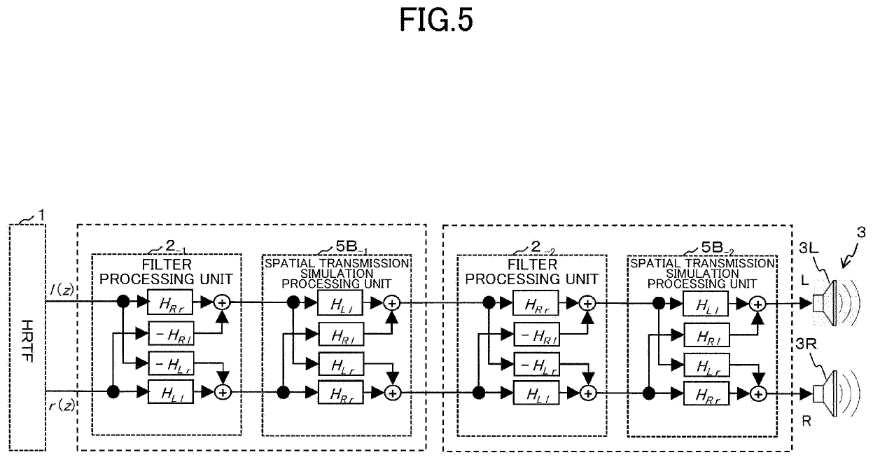

FIG. 5 is a diagram showing a configuration example of the acoustic signal processing apparatus according to a third modification. As shown in FIG. 5, in the acoustic signal processing apparatus according to the third modification, a combined configuration of the filter processing unit 2 and the spatial transmission simulation processing unit 5B shown in FIG. 4 is cascade-connected in multiple stages. In FIG. 5, the listening point 4 is not shown.

In the acoustic signal processing apparatus according to the third modification configured as described above, while supplying the crosstalk component by the processing of filter processing units 2₋₁ and 2₋₂ in the first and second stages, the acoustic characteristics similar to the spatial acoustic characteristics from the stereo speaker 3 to the listening point 4 are applied to the stereo acoustic signal by the processing of the spatial transmission simulation processing units 5B₋₁ and 5B₋₂ in the first and second stages. As a result, the sound reaches the listening point 4 in a state in which the spatial acoustic characteristics from the stereo speaker 3 to the listening point 4 are more strongly influenced, and the sense of distance and spaciousness of the sound can be reproduced more richly.

Although FIG. 5 shows a configuration example in which a combination of the filter processing unit 2 and the spatial transmission simulation processing unit 5B is cascade-connected in two stages, the combination may be cascade-connected in three or more stages.

Further, the first modification may be applied in combination with the second modification, or the first modification may be applied in combination with the third modification. For example, the spatial transfer simulation processing unit 5A may be connected between the spatial transfer simulation processing unit 5B (or the spatial transfer simulation processing unit 5B₋₂) and the stereo speaker 3.

Although the configuration with the head-related transfer function processing unit 1 has been described in the above embodiments and first to third modifications, the configuration is not limited to this. By including the head-related transfer function processing unit 1, it is possible to localize a desired sound image in the sound that reaches the listener's ear at the listening point 4, but even without the head-related transfer function processing unit 1, it is possible to obtain the effect of reducing crosstalk without impairing the stability of the system.

In addition, the above embodiments are merely examples of embodiments for carrying out the present disclosure, and the technical scope of the present disclosure should not be construed as being limited by them. That is, the present disclosure can be carried out in various forms without departing from the gist or main features of the present disclosure.

Each of the processing units described above, such as the filter processing unit 2, the head-related transfer function processing unit 1, and the spatial transmission simulation processing units 5A and 5B, may be implemented by hardware such as an FIR filter, or alternatively by a processor such as a central processing unit (CPU) or a digital signal processor (DSP) executing program(s), or by a combination of hardware and software. Each processing unit may include a memory for storing the program(s) and/or filter coefficients.

In the present disclosure configured as described above, since a function having only a numerator and no denominator is used as a filter transfer function of a filter processing unit, instability in which the denominator of the filter transfer function becomes zero, causing the function to diverge to infinity, can be eliminated. Further, since a function including a sign-inversion transfer function of a crosstalk component is used as a filter transfer function of the filter processing unit, sound in which a crosstalk component is canceled in a transmission path from a stereo speaker to the left and right listening points can be output from the stereo speaker. Thus, in a sound reproduction system using the stereo speaker, crosstalk can be reduced without impairing the stability of the system.

What is claimed is:

1. An acoustic signal processing apparatus comprising:
filter processing circuitry configured to:
filter an input stereo acoustic signal with a filter coefficient implementing a predetermined transfer function, and
output the filtered stereo acoustic signal from a stereo speaker,
wherein the predetermined transfer function of the filter processing circuitry is a function including only a numerator and no denominator, the predetermined transfer function including a sign-inverted transfer function obtained by inverting a sign of a transfer function representing a spatial acoustic characteristic of a crosstalk component of sound that travels from the stereo speaker to left and right listening points.

2. The acoustic signal processing apparatus according to claim 1, further comprising:
spatial transmission simulation processing circuitry configured to:
filter the stereo acoustic signal output from the filter processing circuitry with a filter coefficient implementing a simulated transfer function that simulates a predetermined spatial acoustic characteristic from the stereo speaker to the left and right listening points, the simulated transfer function being a function including only the numerator and no denominator, and
output, from the stereo speaker, the stereo acoustic signal that is filtered by the filter processing circuitry and the spatial transmission simulation processing circuitry.

3. The acoustic signal processing apparatus according to claim 2, wherein the stereo speaker includes a left speaker and a right speaker, and
wherein the simulated transfer function is a function that does not include a transfer function representing the spatial acoustic characteristic of the crosstalk component, and is a transfer function configured to:
simulate a spatial acoustic characteristic of a direct component reaching the left listening point from the left speaker, and
simulate a spatial acoustic characteristic of a direct component reaching the right listening point from the right speaker.

4. The acoustic signal processing apparatus according to claim 2, wherein the simulated transfer function is a function that includes a transfer function representing the spatial acoustic characteristic of the crosstalk component, the simulated transfer function being configured to simulate a spatial acoustic characteristic from the stereo speaker to the left and right listening points.

5. The acoustic signal processing apparatus according to claim 4, wherein a combination of the filter processing circuitry and the spatial transmission simulation processing circuitry is cascade-connected in a plurality of stages.

6. The acoustic signal processing apparatus according to claim 1, further comprising:
head-related transfer function processing circuitry configured to:
generate the stereo acoustic signal by filtering an acoustic signal with a filter coefficient that implements a head-related transfer function,
wherein the filter processing circuitry is configured to receive the stereo acoustic signal output from the head-related transfer function processing circuitry.

7. The acoustic signal processing apparatus according to claim 1, further comprising:
first adjustment filtering circuitry provided at a stage preceding the filter processing circuitry and configured to adjust input and output characteristics from an input stage of the filter processing circuitry to the left and right listening points.

8. The acoustic signal processing apparatus according to claim 1, further comprising:
second adjustment filtering circuitry provided at a stage preceding the filter processing circuitry and configured to adjust both a direct component and a crosstalk component of sound that reaches the left and right listening points.
